(19) United States
(12) Patent Application Publication
(10) Pub. No.: US 2016/0339739 A1
(43) Pub. Date: Nov. 24, 2016

(54) Decorative Wheel Tip

(71) Applicant: Frank Hodges, Irvine, CA (US)

(72) Inventor: Frank Hodges, Irvine, CA (US)

(21) Appl. No.: 14/719,855

(22) Filed: May 22, 2015

(51) Int. Cl. B60B 7/06; B60B 7/14; B60B 7/02

(52) U.S. Cl. CPC B60B 7/061; B60B 7/02; B60B 7/14

(57) ABSTRACT

The invention comprises a decorative wheel tip to a fix to the outside surface of a wheel spoke to create the appearance of a longer spoke for custom wheels that use a decorative lip insert. Current wheel designs utilize a decorative lip insert that requires spokes to be cut short to accommodate the decorative lip insert because the insert must pass between the spoke and the inner surface of the wheel tof create multi-piece appearance.

### CROSS-REFERENCE TO RELATED APPLICATION

This application claims priority to U.S. provisional application No. 62/002,583 filed May 23, 2014 the contents of which are hereby incorporated by reference.

### BACKGROUND OF THE INVENTION

The present invention relates to a spoke extender for mounting on a vehicle wheel. The invention has particular application in relation to wheels for a motor vehicle. Aspects of the invention relate to a device, to a spoke extender, to a wheel and to a vehicle.

U.S. Pat. No. 6,712,432 issued to John C. Cheng discloses a wheel cover simulating a high profile automotive wheel and tire.

U.S. Pat. No. 4,441,762 issued to William J. Segal discloses a decorative wheel covering for providing a multiplicity of designs.

U.S. Pat. No. 4,381,537 issued to David K. Hinrichs discloses an illusionary wheel cover structure.

U.S. Pat. No. 4,606,582 issued to Perry A. Warrant discloses a decorative wheel covering.

The above referenced patents and patent applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

Although various decorative wheel covers are known to the art, all, or almost all of them suffer from one or more than one disadvantage. Therefore, there is a need to provide a decorative wheel tip that is inexpensive and easily installed with current style wheels.

### SUMMARY OF THE INVENTION

The present invention relates in general to decorative wheel tips. The current invention makes it possible for a vehicle owner to customize the appearance of their wheels inexpensively. The decorative wheel tip can easily be installed with adhesive, screws, bolts, or any combination thereof. The decorative wheel tip can be made of various hard polymers like ABS. Other materials such as metal could be used and in particular aluminum. The decorative wheel tip will generally be quite thin at less than one inch of thickness and the width of a single spoke on a wheel. Additionally, the decorative wheel tip will generally be painted or coated to match the wheel or add a contrasting color. Additionally, decorative rivets, bolts, gems or other decorative accents may be added to the surface of the decorative wheel tip.

### BRIEF DESCRIPTION OF THE FIGURES

FIG. 1 is a front view of a preferred embodiment wherein the decorative wheel tip is affixed to a wheel.

FIG. 2 is a cross-section view of a preferred embodiment wherein the decorative wheel tip is not affixed to a wheel.

FIG. 3 is a cross-section view of a preferred embodiment wherein the decorative wheel tip is affixed to a wheel.

FIG. 4 is a cross-section view of an alternative preferred embodiment wherein the decorative wheel tip is affixed to a wheel.

FIG. 5 is a front view rendering of a preferred embodiment wherein there is no decorative wheel tip to compare to FIG. 6 which does have a decorative wheel tip affixed to a wheel.

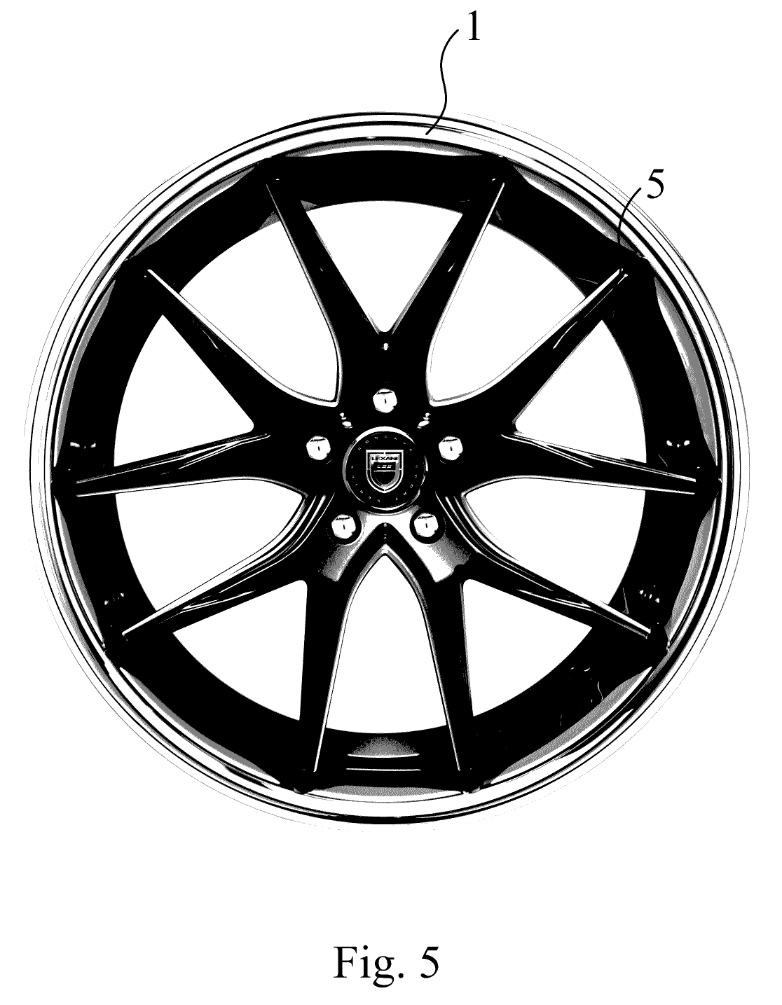

FIG. 6 is a front view rendering of a preferred embodiment wherein there is a decorative wheel tip affixed to a wheel.

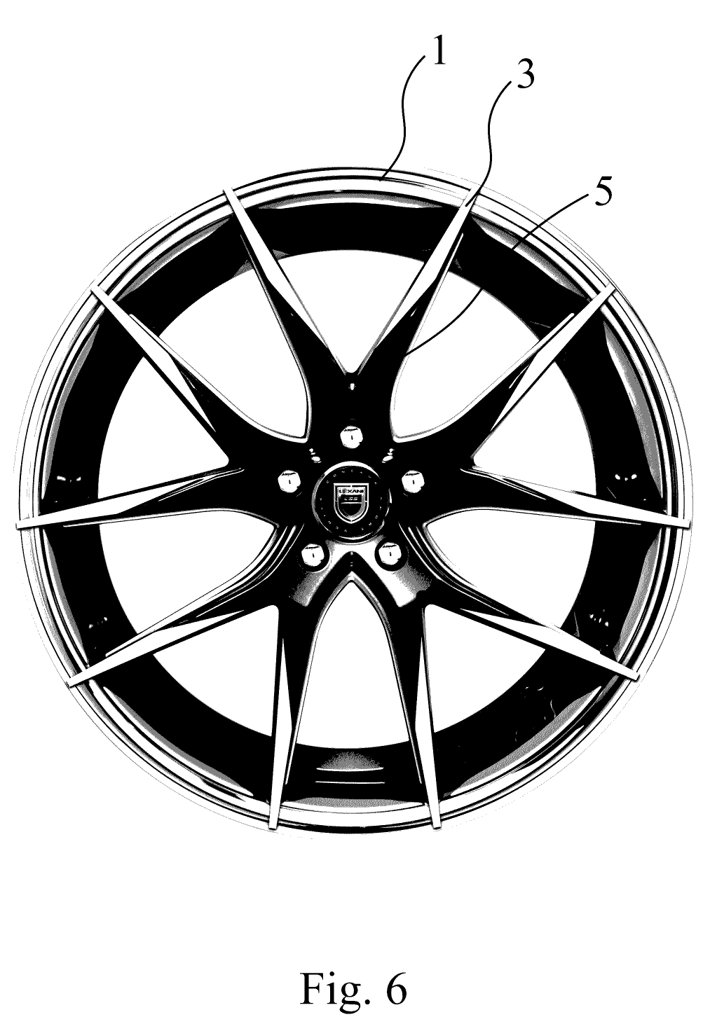

FIG. 7 is a front view rendering of a preferred embodiment wherein there is no decorative wheel tip to compare to FIG. 8 which does have a decorative wheel tip affixed to a wheel.

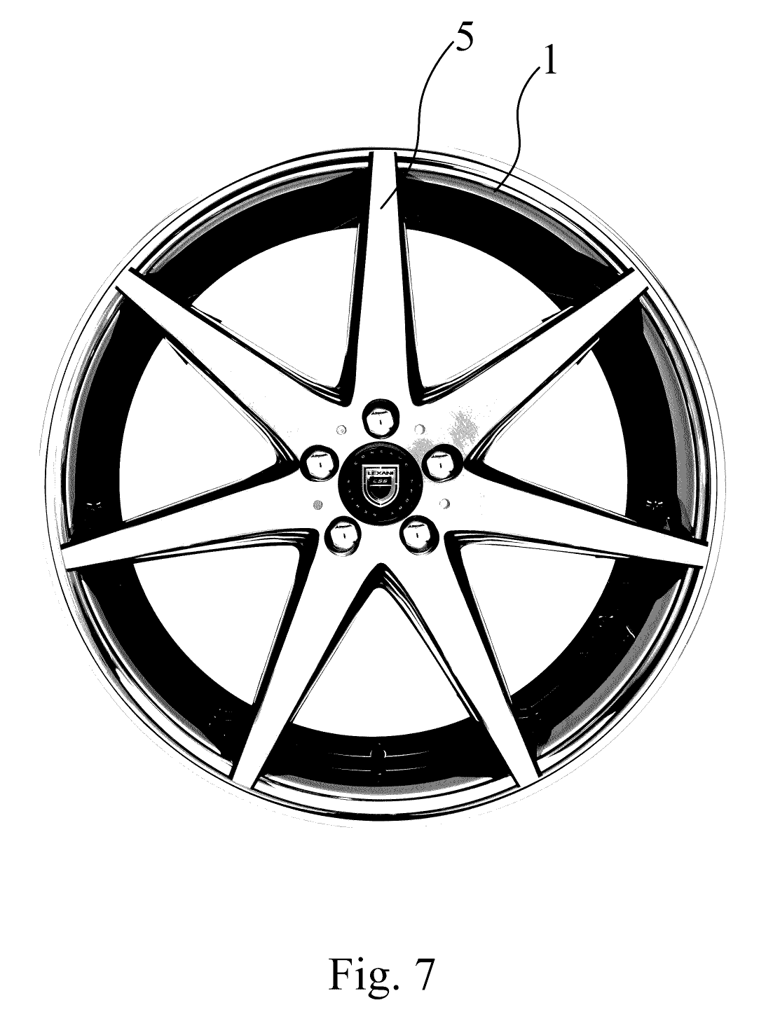

FIG. 8 is a front view rendering of a preferred embodiment wherein there is a decorative wheel tip affixed to a wheel.

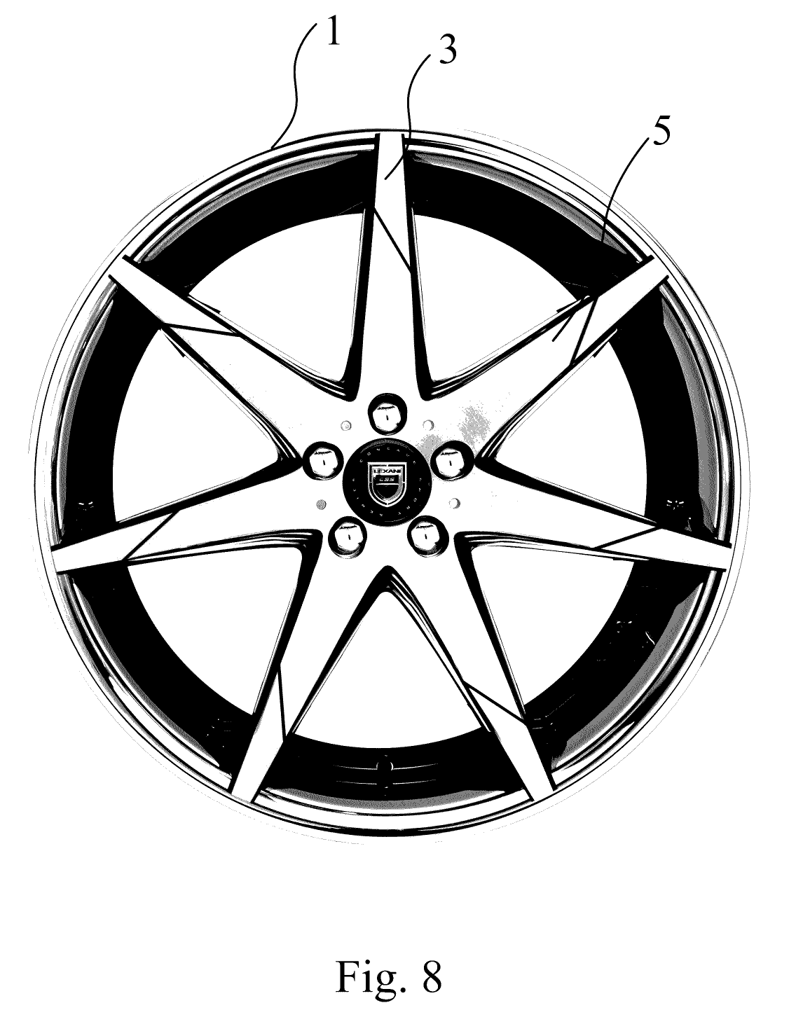

FIG. 9 is an oblique front view rendering of a preferred embodiment wherein there is a decorative wheel tip affixed to a wheel.

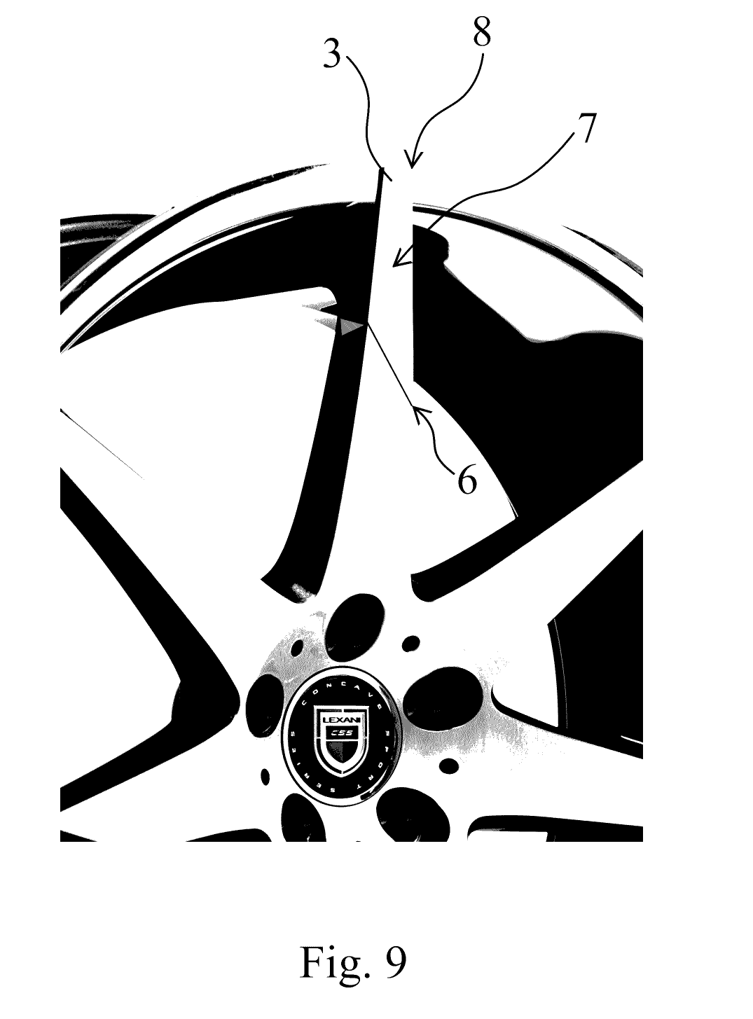

### DETAILED DESCRIPTION

The present invention relates in general to decorative wheel tips. The current invention makes it possible for a vehicle owner to customize the appearance of their wheels. The decorative wheel tip can easily be installed with adhesive, screws, bolts, or any combination thereof. The decorative wheel tip can be made of various hard polymers like ABS. Other materials such as metal could be used and in particular aluminum. The decorative wheel tip will generally be quite thin at less than one inch of thickness. Also, the width of the decorative wheel tip will generally only be as wide as a wheel spoke, though various shapes are expected to create complementary surfaces between the existing spoke and the decorative wheel tip.

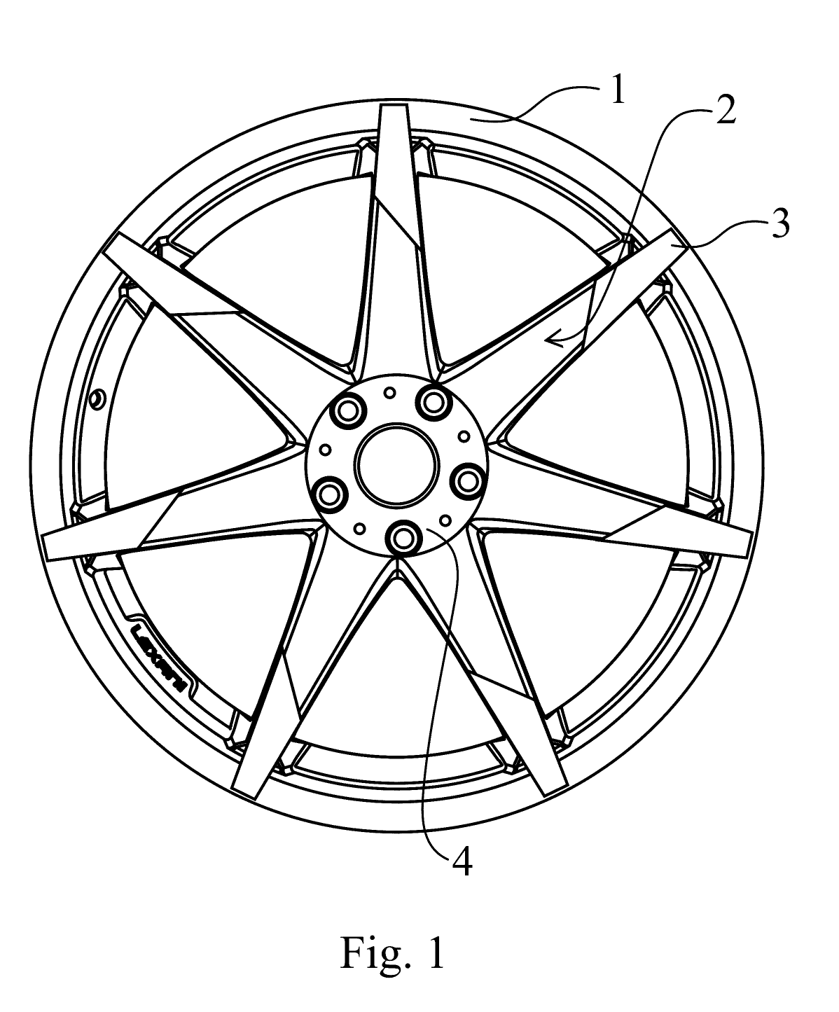

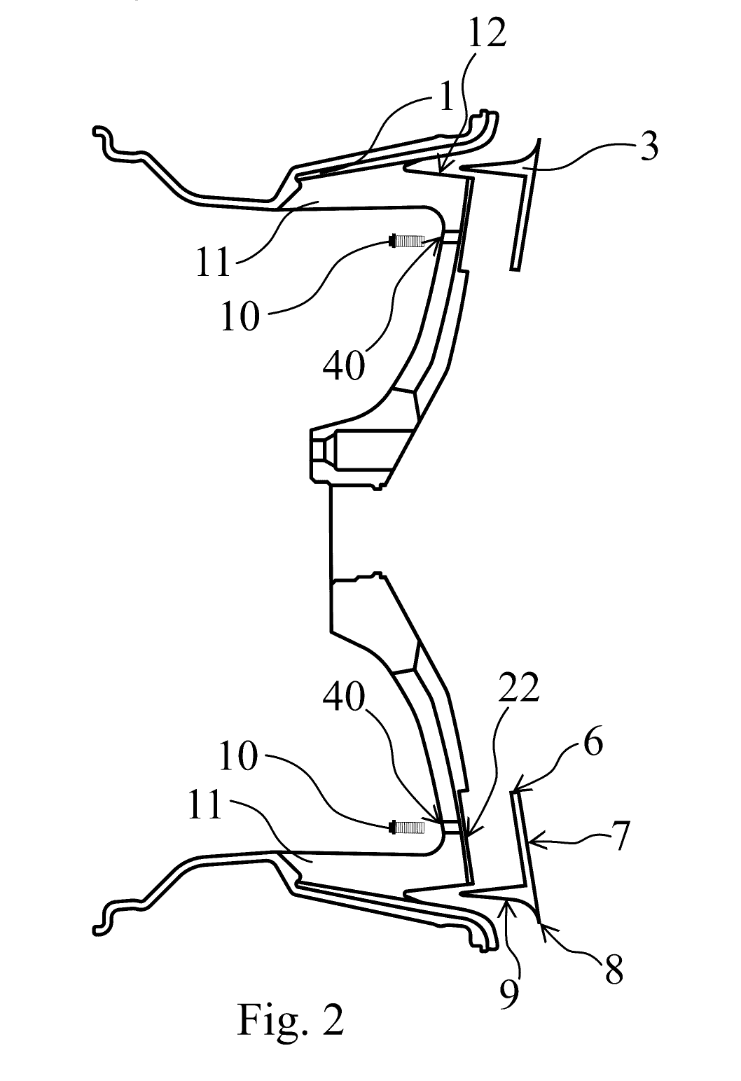

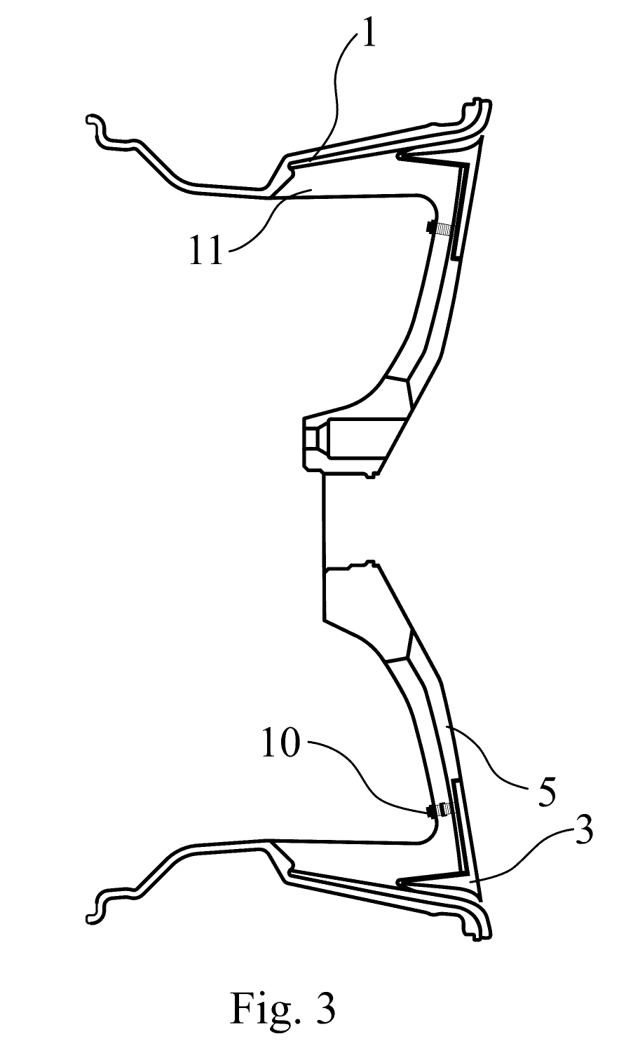

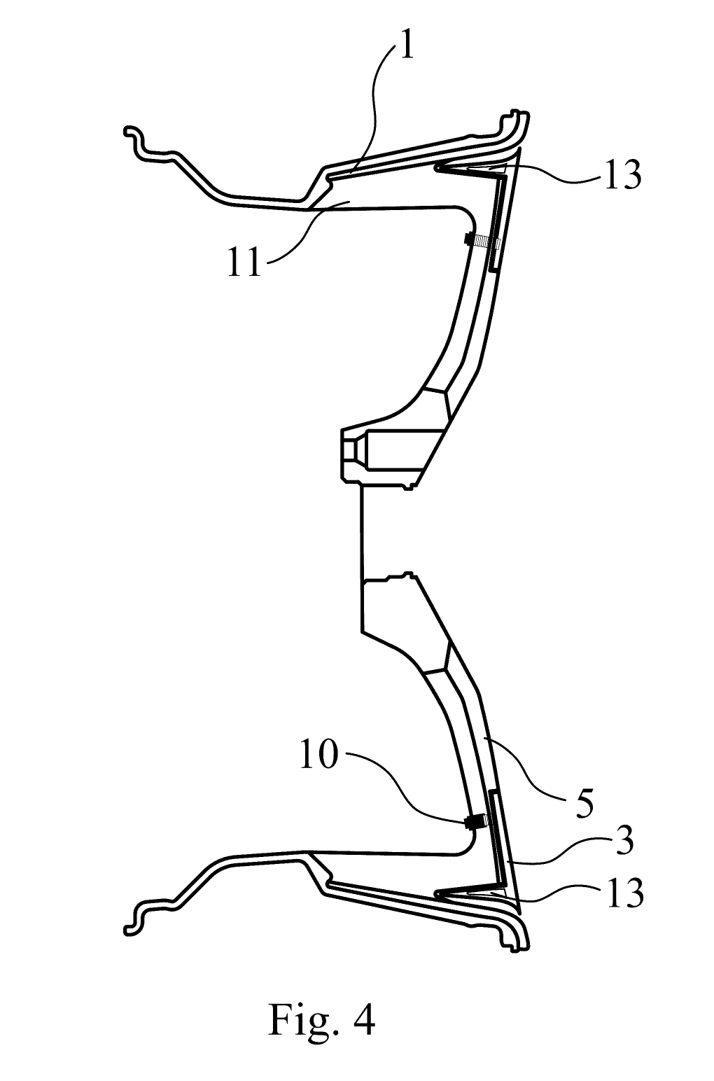

FIGS. 1-3 illustrate a preferred embodiment of the current invention. Specifically, a decorative lip 1 covers a portion of wheel 11 that creates a slight gap 12 because the decorative lip 1 is designed to have a slight taper to frictionally engage the wheels 11 during insertion. Because current wheel designs utilize a decorative lip 1 to create the appearance of a multi-piece custom wheel a spoke 5 must be cut short to enable a manufacturer to slide the decorative lip 1 over a portion of the wheel 11. If the spoke 5 was not short the decorative lip 1 would not have a gap 12 and would then require deep cuts to accommodate the spokes 5 which would leave an unsightly space between the decorative lip 1 and the wheel 11 behind each spoke 5. The decorative wheel tip 3 is attached to the spoke 5 with a bolt 10 through a bolt hole 40. Alternative methods of attachment include adhesive and screws and are well known in the custom wheel industry. The decorative wheel tip 3 has a spoke surface 6 for complementing the spoke 5 and wheel spoke surface 22. For the sake of clarity, a surface portion 22 of the spoke 5 is covered by the decorative wheel tip 3 and surface portion 2 of the spoke 5 is not covered by the decorative wheel tip 3. Additionally, the decorative wheel tip 3 has a lip surface 9 for complementing a decorative lip 1. Further, the decorative wheel tip 3 has distal surface 8 that extends over gap 12 but does not extend beyond the flange of the decorative lip 1. In an alternative embodiment the distal surface 8 could extend past the flange of the decorative lip 1 and even as far as to cover a portion of a tire (not shown). The decorative wheel tip 3 further has a gap surface 9 that wedges between the wheel 11 and decorative lip 1. Additionally, decorative wheel tip 3 has a decorative surface 7 that is generally painted or coated to match the wheel or add a contrasting color. Additionally, decorative rivets, bolts, gems or other decorative accents may be added to the decorative surface 7 of the decorative wheel tip 3. FIG. 4 shows an alternative embodiment of the decorative wheel tip 3 wherein the material does not necessarily need to be solid to reduce overall mass. In FIG. 4 a window 13 is created to pass through the entire width of the decorative wheel tip 3 to add additional design features to the overall look of the custom wheel. Therefore, the current invention overcomes the need to have multiple manufacturing steps to create custom multi-piece wheel designs.

The decorative wheel tip 3 can be of any shape but generally will complement the existing spoke 5 and give the appearance of a larger wheel due to the overall increased length of the spoke. Generally, the decorative wheel tip 3 will not extend to the wheel center 4 but designs could incorporate long decorative wheel tips 3 that wrap around or interdigitate with spoke 5 for custom looks.

In an alternative embodiment the decorative wheel tip 3 is not required to have a portion fill any of gap 12 in which case the gap surface 9 would complement the decorative surface 7 with a relatively uniform thickness.

While the foregoing description sets forth various examples and details relating to preferred embodiments, it should be appreciated that the description is illustrative only and should not to be construed as limiting the invention. Thus, the scope of this disclosure is not to be limited by the illustrations or the foregoing descriptions thereof, but rather solely by the appended claims.

What is claimed is:

1. A decorative wheel tip comprising a spoke surface 6, a decorative surface 7, a distal surface 8, and a gap surface 9 wherein the spoke surface is complementary to a portion of a spoke, the distal surface does not extend beyond a flange portion of a decorative lip 1 covering a portion of a wheel 11, and the gap surface is wedged between the decorative lip 1 and the wheel 11.

2. A decorative wheel tip of claim 1 that may be attached to a spoke with a bolt, screw, and adhesive or a combination thereof.

3. A decorative wheel tip of claim 1 that may be attached to a wheel and decorative lip with a bolt, screw, and adhesive or a combination thereof.

4. The decorative wheel tip of claim 1, wherein the decorative wheel tip is made of plastic.

5. The decorative wheel tip of claim 1, wherein the decorative wheel tip is made of metal.

6. The decorative wheel tip of claim 1, wherein the decorative wheel tip decorative surface is painted.

7. The decorative wheel tip of claim 1, wherein the decorative wheel tip decorative surface is chrome.
